(19) United States
(12) Patent Application Publication
(10) Pub. No.: US 2016/0203264 A1
(43) Pub. Date: Jul. 14, 2016

(54) SYSTEMS, METHODS, AND COMPUTER PROGRAM PRODUCTS FOR PROCESSING MEDICAL IMAGES TO ADDRESS PRIVACY CONCERNS

(71) Applicant: Intelemage, LLC, Cincinnati, OH (US)

(72) Inventors: John Edward Danner, Cincinnati, OH (US); Terry Patrick Gieske, Crestview Hills, KY (US)

(73) Assignee: Intelemage, LLC, Cincinnati, OH (US)

(21) Appl. No.: 14/991,620

(22) Filed: Jan. 8, 2016

Related U.S. Application Data
(60) Provisional application No. 62/101,506, filed on Jan. 9, 2015.

(51) Int. Cl. G06F 19/00; H04N 1/44; G06K 9/46

(52) U.S. Cl. CPC G06F 19/321; G06K 9/4609; G06F 19/322; H04N 1/4493

(57) ABSTRACT

Methods, systems, and computer program products for redacting sensitive or identifying information burned into a medical image. The medical image is received and identification data is read from the medical image. The information burned into the medical image is redacted based on the identification data.

### RELATED APPLICATION

This application claims the benefit of U.S. Provisional Application Ser. No. 62/101,506, filed Jan. 15, 2015, entitled SYSTEMS, METHODS, AND COMPUTER PROGRAM PRODUCTS FOR PROCESSING MEDICAL IMAGES TO ADDRESS PRIVACY CONCERNS, which application is incorporated herein by reference in its entirety.

### TECHNICAL FIELD

The present invention generally relates to electronic medical images and, more particularly, to the processing of such medical images for addressing privacy concerns in the use and sharing of the images.

### BACKGROUND

Medical imaging has made a significant contribution to improvements in diagnosing and treating many injuries and illnesses. There are many different types of medical imaging available including X-ray imaging, magnetic resonance imaging, computerized tomography, ultrasonic scanning, endoscopic imaging and nuclear imaging. As medical imaging techniques are continuously improving and evolving, physicians are able to provide patients with more informed diagnoses and more effective treatments and recovery plans. Patients who require specialist advice are, in many cases, able to present a copy of their medical images at an appointment with the specializing physician. There are also occasions where treating physicians, even specialists, have a need to share medical images with colleagues for an opinion or diagnosis. These colleagues may be located in other medical facilities, which may also be located in other locations of the country or even overseas. As communications technology has developed, it has now become possible to pass vast quantities of information including images and accompanying data from one location to another over communications networks such as telephone networks and dedicated high speed communications networks. This technology facilitates sharing of medical information and images between physicians, where compatible communication platforms and protocols are used, as well as where common network connections are available.

While the exchange of medical data helps to further medical research and development, and can also serve educational purposes, the sharing of medical data also brings up privacy concerns. Medical data may contain sensitive or identifying information, the sharing of which, without authorization, could violate both ethical obligations and patient privacy laws (e.g., HIPAA). Hence, a technician often must redact or mask information from the data before it is shared. Medical images are an example of such medical data.

Devices used to create and store different types of medical images usually differ from one another and devices that create digital records of the images often use different file formats and different protocols to compress and de-compress the image data. To overcome these differences, the Digital Imaging and Communications in Medicine (DICOM) standard was developed to meet the needs of users and manufacturers of medical imaging equipment for interconnection of devices on standard networks including the Internet. DICOM has become the most common standard for receiving digital medical images such as scans from a hospital. A primary advantage of the DICOM standard is that a piece of medical equipment or software produced by one manufacturer can communicate with software or equipment produced by another. Therefore, DICOM image data can be utilized by any party with access to a DICOM compatible viewer. Today, most medical images are exchanged in the DICOM format, which incorporates a data header containing informational fields relating to the image. Some of the fields in the header describe the system used to generate the image, while other fields in the header identify the patient from which the image was taken. Conventional systems exist that clear the header fields containing identifying or otherwise sensitive information. Such systems, however, are ineffective when the sensitive or identifying information is “burned” directly into the pixels of the image, e.g., when a portion of the pixels of the image form an image of textual information.

Under current practice, for burned-in sensitive or identifying information, technicians engage in an inefficient process of manually identifying burned-in information that the technician desires to mask. This process, which requires the technician to individually view and manually search each processed medical image. As such, the process is slow and expensive and can take anywhere from 10 to 20 minutes for an image to be properly processed.

Thus, there exists a need for improved techniques for removing sensitive or identifying information that is burned into or otherwise placed in the pixels of a medical image. There is a further need for a process for rapidly, efficiently and cost-effectively removing sensitive information before an image is sent. There is still further a need for automating the review and removal process for images, so that a greater numbers of images might be processed.

### SUMMARY OF THE INVENTION

Various methods and apparatus are provided for removing sensitive or identifying information in a medical image. The invention includes obtaining information from the image, including header/metadata and/or pixel data, and processing the information to select a masking template. In one embodiment a medical image is received using at least one processor, and the medical image includes pixel data and identification data. Then identification data associated with the medical image is obtained. One or more pixel blocks of the pixel data from the medical image are sampled and then processed to evaluate their content. Using the identification data and sampled pixel data, a masking template is determined for the image and applied to the medical image to mask the information in the medical image. The invention maybe implemented in a method, system or computer program product as appropriate.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a plurality of computing systems/servers in communication via a network in accordance with an embodiment of the invention.

FIG. 2. is a diagrammatic view of an exemplary computing system/server such as for use in the environment of FIG. 1 in accordance with an embodiment of the invention.

FIG. 3 is a schematic view of an exemplary medical image processing system in accordance with an embodiment of the invention.

FIGS. 4A and 4B are schematic views of an exemplary organizational structure for a masking template database as used in the medical image processing system of FIG. 3 in accordance with an embodiment of the invention.

FIG. 5 is a schematic view of exemplary image header data relating to a medical image in accordance with an embodiment of the invention.

FIG. 6 is a flowchart of an exemplary process for redacting sensitive or identifying information from a medical image in accordance with an embodiment of the invention.

FIG. 7 is a flowchart of another exemplary process for redacting sensitive or identifying information from a medical image in accordance with an embodiment of the invention.

FIGS. 8A and 8B are, respectively, screenshots of an exemplary standard medical image with sensitive information before a masking template is applied and without certain sensitive information after a masking template is applied in accordance with an embodiment of the invention.

FIGS. 9A and 9B are, respectively, screenshots of an exemplary report medical image with sensitive information before a masking template is applied and without certain sensitive information after a masking template is applied in accordance with an embodiment of the invention.

### DETAILED DESCRIPTION OF THE INVENTION

Embodiments of the invention include methods and systems for redacting or masking sensitive and/or identifying information burned into the pixels of a medical image. A medical imaging processing system that includes one or more networked computers and/or servers may implement such embodiments. The networked computers and/or servers may include an image processing system, a masking template server, a user system, and/or a medical imaging system or server. Any of these systems or servers may provide processing and/or database functions for modules operative to redact or mask information burned into a medical image.

The medical imaging processing system may include a masking template database. The masking template database contains a plurality of masking templates configured to mask or redact sensitive or identifying information burned into a medical image. The exact pixel coordinates of sensitive or identifying information burned into a medical image largely depend on the system and/or process used to generate the image, and thus the database contains a number of different masking templates in accordance with the invention. Consequently, each of the masking templates corresponds to a specific system and/or process for a specific image that is determined in accordance with the invention. Thus, when a proper and appropriate masking template is selected in accordance with the invention and applied to a corresponding image (i.e., an image generated by the specific system and/or process corresponding to the template), sensitive or identifying information is redacted therefrom.

The medical image processing system may also include a masking module configured to determine and obtain identification data and other data from a medical image and thereby identify the appropriate masking template corresponding to the image. Thereafter, the masking module is able to determine and retrieve the identified masking template from the masking template database and apply the template to the medical image. The medical image, now without any sensitive or identifying information, can then be shared with a user system for the purposes of data collection or research, for example, and without raising the same privacy concerns as if the information was present.

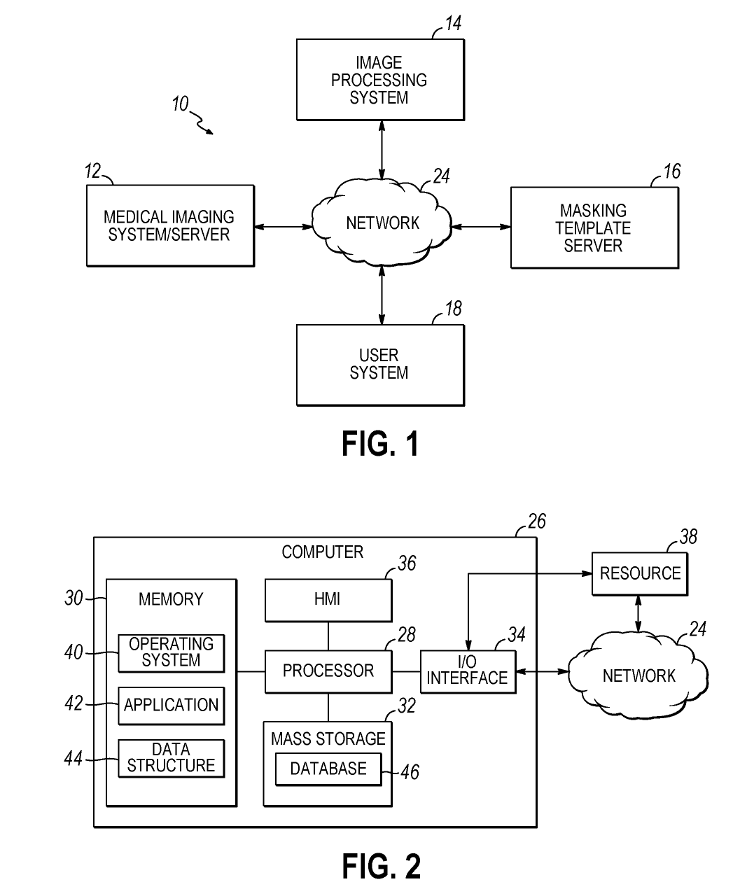

FIG. 1 provides an exemplary embodiment of an operating environment 10 for redacting information on a medical image in accordance with aspects of the invention. Operating environment 10 includes one or more medical imaging systems/servers 12, one or more image processing systems 14, one or more masking template servers 16, and one or more user systems 18. Each of medical imaging system/server 12, image processing system 14, masking template server 16, and user system 18 may communicate with each other via an appropriate network 22, such as the Internet or a suitable private network. Alternatively, any two or more of medical imaging system 12, image processing system 14, masking template server 16, and user system 18 may communicate via a direct connection or be integrated with one another directly.

Medical imaging system/server 12 is an appropriate system that facilitates the generation and/or storage of medical images. For example, medical imaging system/server 12 may include a system operable to generate an X-ray, CAT scan, MRI, PET scan, and/or any other type of medical image used for medical research, diagnosis, or treatment. As such, the present invention is not limited to the type of medical image that is used or processed in accordance with the invention. In addition or alternatively, medical imaging system/server 12 may include a storage device (not separately shown) that maintains a database of previously generated medical images. Furthermore, although the illustrated embodiment of FIG. 1 shows singular elements of the medical imaging system 12, image processing system 14, masking template server 16, and user system 18, it is understood that multiple of such elements may be interconnected and operable for achieving the invention as described herein.

Before a medical image containing sensitive information, such as burned-in sensitive or identifying information is shared, such as for data collection or research purposes, image processing system 14 receives the medical image from one or more medical imaging systems/servers 12 for processing. Such systems/servers 12 may be located in a variety of different facilities, such as hospitals, surgery centers, imaging centers, doctors' offices, etc. To this end and in accordance with features of the present invention, image processing system 14 processes the medical image to redact or mask any sensitive or identifying information contained therein. Image processing system 14 is configured to process the image and determine identification data and other data associated with the medical image, to communicate with one or more masking template servers 16, and retrieve one or more the masking templates corresponding to the medical images that are being processed, based on the determined identification data and other data from the medical image. The identification data, described in more detail below, thus provides a link to the most appropriate masking template and informs image processing system 14 and/or masking template server 16 of the appropriate masking template corresponding to the current medical image to be processed in accordance with the invention. After receiving this masking template from the one or more masking template servers 16, imaging processing system 14 applies the appropriate masking template to the medical image so that any sensitive or identifying information contained in the image is redacted and/or hidden from view. In that way, the image might be further processed and or transmitted without concern to various parties.

User system 18 is representative of one or more user systems that are associated with parties and other users that will receive the processed image from image processing system 12. The user system will facilitate viewing of the images by one or more users or parties that have in interest in the image. Because any sensitive or identifying information on the original medical image is now redacted or removed in accordance with the invention, a user can view the image on user system 18 for the purpose of anonymous data collection or research, for example, without raising undesirable privacy concerns with respect to the patient source of the image. User system 18 can be any conventional computing device or computer, such as a laptop computer, thin client terminal, desktop computer, mobile phone, tablet, or similar stationary or mobile computing device and so the invention is not limited to the type of user system that might be used to view images processed in accordance with the invention.

Referring now to FIG. 2, a suitable and exemplary computing device or system or computer is illustrated that might be used for implementing one or more components of the operating environment 10 of the invention. For example, one or more medical imaging systems/servers 12, one or more image processing systems 14, one or more masking template servers 16, and one or more user systems 18 of operating environment 10 may be implemented on one or more computing/computer devices or systems, such as exemplary computer device or system 26 illustrated in FIG. 2. The computer device/system 26 may be referred to herein as a “computer” or “apparatus” and the terms may include other suitable programmable electronic devices/systems. The computer system or computer 26 may include a one or more processors 28 (e.g. microprocessors) coupled with suitable memory 30. Memory 30 may represent the random access memory (RAM) devices comprising the main storage of computer 26, as well as any supplemental levels of memory, e.g., cache memories, non-volatile or backup memories (e.g. programmable or flash memories), read-only memories, etc. In addition, memory 30 may be considered to include memory storage physically located elsewhere in computer 26, e.g., any cache memory in a processor 28, as well as any storage capacity used as a virtual memory, e.g., as stored on a mass storage device 32 or another computer device/system coupled to computer 26 via a network 24.

Computer 26 also includes a mass storage memory device 32, an input/output (“I/O”) interface 34, and a Human Machine Interface (“HMI”) 36. The computer 26 may also be operatively coupled to one or more external resources 38 via network 24 or one or more suitable I/O interfaces 34. External resources may include, but are not limited to, servers, databases, mass storage devices, peripheral devices, cloud-based network services, or any other suitable computer resource that may be used by the computer 26.

The processor 28 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 30. Memory 30 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 32 may include data storage devices such as a hard drive, optical drive, tape drive, non-volatile solid state device, or any other device capable of storing information.

Processor 28 may operate under the control of an operating system 40 residing in memory 30. The operating system 40 may manage computer resources so that computer program code embodied as one or more computer software applications, such as one or more applications 42 residing in memory 30, may have instructions executed by the processor 28. In an alternative embodiment, the processor 28 may execute the application 42 directly, in which case the operating system 40 may be omitted. The computers 26 and appropriate processor(s) execute or otherwise rely upon various computer software applications, components, programs, objects, modules, data structures, etc as part of the operating system 40 or applications 42. One or more data structures 44 may also reside in memory 30, and may be used by the processor 28, operating system 40, or applications 42 to store or manipulate data.

The I/O interface 34 may provide a machine interface that operatively couples the processor 28 and computer 26 to other devices and systems, such as the network 24 or external resource 38. The applications 42 may thereby work cooperatively with the network 24 or external resource 38 by communicating via the I/O interface 34 to provide the various features, functions, applications, processes, or modules comprising embodiments of the invention. The applications 42 may also have program code that is executed by one or more external resources 38, or otherwise rely on functions or signals provided by other system or network components external to the computer 26. Indeed, given the nearly endless hardware and software configurations possible, persons having ordinary skill in the art will understand that embodiments of the invention may include applications that are located externally to the computer 26, distributed among multiple computers or other external resources 38, or provided by computing resources (hardware and software) that are provided as a service over the network 24, such as a cloud computing service.

The HMI 36 may be operatively coupled to the processor 28 of computer 26 in a known manner to allow a user or operator to interact directly with the computer 26. The HMI 36 may include video or alphanumeric displays, a touch screen, a speaker, and any other suitable audio and visual indicators capable of providing data to the user. The HMI 36 may also include input devices and controls such as an alphanumeric keyboard, a pointing device (e.g., mouse, trackball, joystick, stylus, etc), keypads, pushbuttons, control knobs, microphones, etc., capable of accepting commands or input from the user and transmitting the entered input to the processor 28. The interface or HMI 36 to computer 26 may also be through an external terminal connected directly or remotely to computer 26, or through another computer communicating with computer 26 via a network 18, modem, or other type of communications.

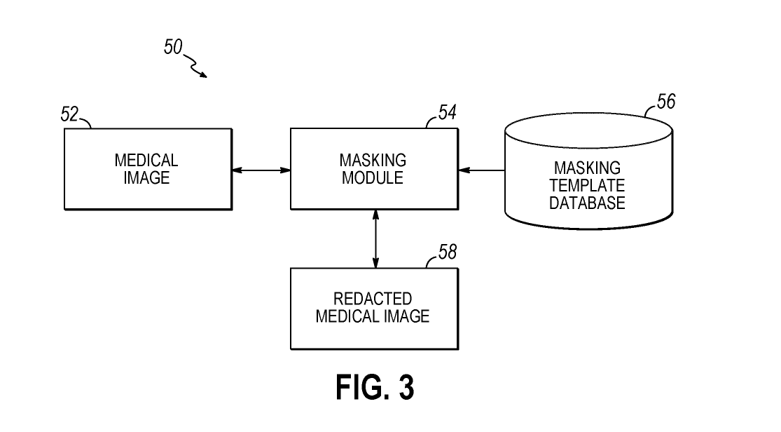

A database 46 may reside on the mass storage memory device 32, and may be used to collect and organize data used by the various systems and modules described herein. The database 46 may include data and supporting data structures that store and organize the data. In particular, the database 46 may be arranged with any database organization or structure including, but not limited to, a relational database, a hierarchical database, a network database, or combinations thereof. A database management system in the form of a computer software application executing as instructions on the processor 28 may be used to access the information or data stored in records of the database 46 in response to a query, where a query may be dynamically determined and executed by the operating system 40, other applications 42, or one or more modules. In one embodiment, the database 46 may comprise a masking template database 56 (FIG. 3) including a plurality of masking templates that, when applied to corresponding medical images, redacts sensitive or identifying information therefrom.

In general, the routines and applications executed to implement the embodiments of the invention, whether implemented as part of an operating system or a specific application, component, program, object, module or sequence of instructions or subset thereof, will be referred to herein as “computer program code”, or simply “program code”. The computer program code typically comprises one or more computer readable instructions that are resident at various times in various memory and storage devices in a computer, and that, when read and executed by one or more processors in a computer, causes that computer to perform the operations necessary to execute operations, steps or elements embodying the various aspects of the embodiments of the invention. Computer readable program instructions for carrying out operations of embodiments of the invention may be, for example, assembly language or either source code or object code written in any combination of one or more programming languages. Moreover, while the invention has and hereinafter will be described in the context of fully functioning computers and computer systems, those skilled in the art will appreciate that the various embodiments of the invention are capable of being distributed as a program product in a variety of forms. In particular the program code may be distributed using a computer readable storage medium having computer readable program instructions thereon for causing a processor to carry out aspects of embodiments of the invention. The invention applies equally regardless of the particular type of computer readable storage media used to actually carry out the distribution, e.g., physical, recordable type storage media such as volatile and non-volatile memory devices, floppy and other removable disks, hard disk drives, optical disks (e.g., CD-ROM's, DVD's, etc.).

In addition, various program code described hereinafter and as reflected in flow diagrams may be identified based upon the application or software component within which it is implemented in specific embodiments of the invention. However, it should be appreciated that any particular program nomenclature that follows is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium maybe used to direct a computer, other types of programmable data processing apparatus, or other devices to function in a particular manner, such that the instructions stored in the computer readable medium produce an article of manufacture including instructions that implement the functions, acts, and/or operations specified in the flowcharts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flowcharts, sequence diagrams, and/or block diagrams.

In certain alternative embodiments, the functions, acts, and/or operations specified in the flowcharts, sequence diagrams, and/or block diagrams may be re-ordered, processed serially, and/or processed concurrently consistent with embodiments of the invention. Moreover, any of the flowcharts, sequence diagrams, and/or block diagrams may include more or fewer blocks than those illustrated consistent with embodiments of the invention.

Those skilled in the art will recognize that the exemplary environment illustrated in FIG. 2 is not intended to limit the present invention. Indeed, those skilled in the art will recognize that other alternative hardware and/or software environments may be used without departing from the scope of the invention

FIG. 3 provides an exemplary embodiment of a medical image processing system 50 for redacting information from a medical image. Medical image processing system 50 includes a masking module 54 operatively coupled to a masking template database 56. Medical imaging processing system 50 may be provided by one or more of medical imaging system/servers 12, image processing systems 14, masking template servers 16, user systems 18, and/or any other suitable system working to provide the functionality of the invention.

In operation, a medical image 52 to be shared, such as for research or data collection, is received at the masking module 54. Medical image 52 includes burned-in sensitive or identifying information to be redacted or hidden before the image is shared in accordance with the invention. Masking module 54 is thus configured to perform the necessary redacting or processing of medical image 52 and to output a redacted medical image 58 as described herein. The masking module is implemented within suitable hardware and software as discussed with respect to FIGS. 1 and 2.

Upon receiving the medical image 52, masking module 54 is configured to obtain (e.g., read) identification data from the medical image 52. The masking module then processes the information, along with additional image information that is determined and evaluated, and then determines an appropriate masking template to be used with the medical image that is being processed. The selected or determined masking template will correspond to the specific processed medical image. To that end, the most appropriate masking template is determined and selected from a plurality of stored masking templates in order to effectively redact sensitive or identifying information that is burned into or otherwise present in the image. The plurality of masking templates that may be implemented upon processing the medical image 52 is stored in a masking template database 56, that may be accessed by the masking module 54. The masking module 54, after processing the medical image 52, is configured to retrieve the masking template corresponding to the medical image 52 based on the identification data and other data that is determined when the medical image is processed in accordance with the invention. Masking module 54 is further configured to apply the retrieved masking template to the medical image 52, thereby redacting any sensitive or identifying information on the image.

In one embodiment, identification data is obtained and read from the medical image 52 and includes data from a header of the image and/or metadata associated with the medical image. The header and/or metadata of the medical image 52 generally includes information about the image and the system or equipment that is used to generate the image. For example, the header and/or metadata of a medical image 52 may include information relating to the modality of the image (e.g., the type of scan, such as a CT scan), to the manufacturer of imaging equipment, to the model number or type of a particular piece of imaging equipment, and/or to the particular software revision or series number associated with the imaging equipment and the operating or imaging software of the system that is used to generate the medical image 52. Furthermore, such data may include information regarding the size of the image, such as pixel row and column information. In one embodiment, the masking templates are organized in the masking template database 56 at least by the information read from the header and/or metadata.

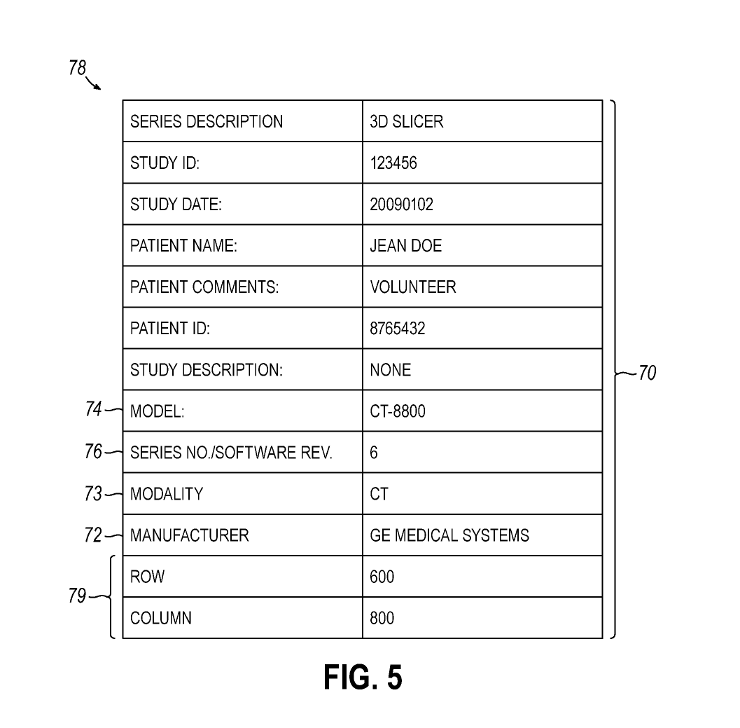

FIG. 5 provides an exemplary illustration of data header and/or metadata of a medical image that might be used in accordance with one aspect of the invention, along with other derived data from the image, for selecting a suitable masking template. As illustrated, the header and/or metadata may include a number of fields 70 indicating the manufacturer 72, modality 73, the model number 74, the software revision 76 of the system, the series description 78 etc., used to generate the medical image. The fields 70 may also include information 79 associated with the size of the image, such as row/column information.

While certain of the header and/or metadata information is used in conjunction with other derived information for determining a masking template in accordance with the invention, other field information 70, such as the “Series Description,” 78 may also be used to organize a plurality of selectable masking templates in the masking template database 56. For example, each of the masking templates may be organized in a database by manufacturer, model number, software revision combination and/or other information. With this organizational structure implemented, masking module 54 is able to quickly identify and retrieve a basic masking template most appropriate for the medical image 52 based on the information evaluated and read from the header and/or metadata.

In additional and alternative embodiments of the invention, the medical image is further processed in accordance with features of the invention for deriving additional data from the medical image. The additional derived data is or may be used with existing data, such as from a header/metadata, for determining the most appropriate masking template for use with the particular image.

For example, in addition or alternatively, the identification data that is used for determining and selecting an appropriate masking template in accordance with the invention, may include pixel data that is sampled from the medical image 52 and processed as described herein. To that end, masking module 54 is configured to sample one or more pixel blocks from the medical image 52, with each pixel block including one or more adjacent pixels. For example, a block could be a single pixel or a plurality of pixels. As another example, a sampled pixel block could form the area of a square, rectangle, line, or some other shape in the reviewed and processed image. The masking module is configured to do the sampling at positions in the image that are either at randomized coordinates within the image or at predetermined coordinates within the medical image 52. Based upon the sampled pixel blocks, and using other data that may have been retrieved from the image, such as header/metadata, the masking module 54 is able to determine an appropriate template for the medical image and then access the masking template database and identify and retrieve the correct masking template corresponding to the processed medical image 52. The sampling of pixel blocks and processing of the medical image pixel data may be done to determine if certain expected pixel data occurs at predetermined coordinates or may be done to determine if patterns exist at predetermined or random coordinates.

In one exemplary embodiment, the masking module 54 is configured to sample pixel blocks at one or more predetermined coordinates of the medical image 52. The masking module is configured for evaluating if certain expected pixel data is located in the image at the predetermined coordinates in the image. The masking module knows the coordinates to be evaluated and the expected pixel data based on the various images that might be processed. For example, the header/metadata that is obtained might be used for then being associated with certain coordinates that would be used for the processing and evaluation for a particular image. The pixel data sampled is compared to the expected pixel data. If the pixel data sampled for one or more pixel blocks matches what is expected for certain coordinates in the image, the information is used for selecting the appropriate template. In this embodiment, the masking templates might then be accessed to obtain the appropriate template from the masking template database 56 using at least processed data including by expected pixel data at the predetermined coordinates. Hence, based on the pixel blocks sampled from the predetermined coordinates, masking module 54 is able to quickly further define and identify the specific image that is being processed and retrieve the appropriate masking template corresponding to the medical image 52.

In another exemplary embodiment of the invention, the masking module 54 is configured to sample pixel blocks at one or more predetermined or random coordinates of the medical image 52 in order to find patterns. For example, random coordinates to use with an image might be generated by a random number generator. Each of the pixel blocks evaluated may be of the same size, for example. The masking module 54 is configured to sample the pixel blocks and compare the sampled pixel blocks and determine patterns among the sampled pixel blocks. If patterns are found between the sampled pixel blocks, such as certain patterns that are indicative of a specific medical image, then the data is used along with other data available for the image for determining the appropriate masking template. The masking templates might thus be organized in the masking template database 56 at least by one or more expected patterns, and based upon the determined patterns that are found in the pixel block sampling and processing. The masking module 54 is able to quickly further define and identify the image that is being processed and retrieve the appropriate masking template corresponding to the medical image 52.

In one embodiment of the invention, the masking module 54 may be configured to determine patterns among the sampled pixel blocks by performing a cross-region matching algorithm. A cross-region matching algorithm is provided by the masking module and compares the sampled pixel blocks to one another within an image and determines those that match. Two pixel blocks match if the same or substantially the same (i.e., differing by less than a threshold value) pixels are present in the same configuration in each pixel block. For example, the matching processing of cross-region matching compares a square pixel block with two upper red pixels and two lower blue pixels so see if it matches another pixel block of the same colors and configuration, but not a square pixel block having two upper blue pixels and two lower red pixels. Such pixel block matching can be performed by the masking module at various locations or coordinates around an image. The number of matches may then be used to further define or identify an appropriate template to select. Furthermore, the specific configurations of the sampled pixel blocks may be used. For example, the existence of a block with upper red pixels and lower blue pixels existing in the image may be used as additional data for selection and determination of a masking template. Based upon the number of sampled pixel blocks that match, as well as upon the pixel configurations of the matching pixel blocks, the masking module 54 is able to quickly further define and identify the image that is being processed and retrieve the masking template corresponding to the medical image 52. For example, the number of pixel blocks that match may be applied to a threshold and if the number of matching pixel blocks exceeds or is equal to the threshold, that information can be used for obtaining the appropriate masking template for the image.

In another exemplary embodiment, it is desirable to evaluate the type of medical image that is being processed as the image may be one of a plurality of types of images. As such, the appropriate template might also be accessed by image type, in combination with any of the above noted data information and database organizational structures that are used. To that end, the masking templates in the masking template database 56 are further divided by type. Medical images 52 can come in a variety of types, such as a “standard” type or a “report” type, for example. In general, a standard type medical image includes an image of a patient, such as a particular scan. On the other hand, a report type medical image is a computer generated image including information relating to an image of the patient, but not necessarily the image of the patient itself. In accordance with one feature of the invention, prior to identifying and retrieving a masking template corresponding to the medical image 52, masking module 54 is configured to determine whether the image 52 is of the standard or report type. Thereafter, the masking module 54 is configured to identify and retrieve a masking template from the subset of masking templates associated with the determined type of image. The masking module then uses additional information, such as from one or more of the above-noted processing techniques (e.g., obtaining header information, sampling pixel data), to determine and obtain a final masking template for use.

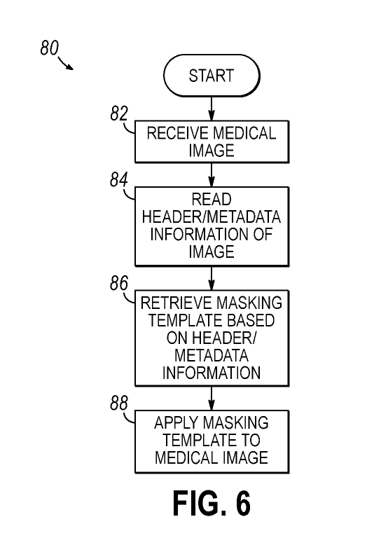

In some embodiments of the invention, the processing data including the header/metadata for an image might be used for either a standard or report image for determining and selecting an appropriate masking template for use. As discussed with respect to FIG. 6 below, a template selected with that initial processed information might be suitable for a large number of images that are to be masked or otherwise have information redacted. However, in other scenarios, there are multiple levels of processing that are used on an image for fine tuning the template determination process to ensure that all the desired data for redaction is addressed. In such scenarios, in addition to using the header/metadata, initial pixel processing is performed for further classifying the image by type. Then, depending on the type of image that is being addressed, additional or secondary pixel processing might be performed for further determining the appropriate masking template.

In some embodiments of the invention, the determination of whether a medical image 52 is of a standard type or a report type may further dictate the additional processing techniques that are used to identify or fine tune the appropriate masking template corresponding to the medical image 52. For example, upon determining that the medical image 52 is of a standard type, the masking module 54 may be configured to use processed information from the header and/or metadata of the medical image 52 to identify a corresponding masking template. Conversely, upon a determination that the medical image 52 is of the report type, the masking module 54 may be configured to do further pixel processing, such as to use sampled pixel blocks, to obtain additional data and information to identify the most appropriate masking template corresponding to the medical image 52.

In some exemplary embodiments, the masking module 54 is configured to determine whether the medical image 52 is of a standard type or a report type by analyzing the one or more sampled pixel blocks as noted in the techniques above. By looking at sampled pixel blocks, patterns of the pixel blocks, certain configurations of pixel blocks, etc, the type of image is ascertained. In general, report type medical images tend to have a constant non-black or non-white background. For type evaluation, the masking module 54 may be configured to remove from the sampled pixel blocks any pixel blocks consisting of all black pixels or all white pixels. This leaves remaining pixel blocks, and from the remaining sampled pixel blocks, the masking module 54 applies the cross-region matching algorithm described above to determine a number of matching pixel blocks. If the total number of pixel blocks that match another pixel block meet or exceed a set threshold, then the masking module 54 is configured to determine that the medical image 52 is a report medical image. Conversely, if the number of matched pixels does not meet or exceed a set threshold, which can be the same or different from the set threshold for determining a report type medical image, then the medical image 52 is determined to be a standard type medical image.

To facilitate determination of a suitable template, the masking templates may be organized based upon their specific type and may be accessed based upon determined or process parameters such as the size of the image, the information in the header/metadata, the determined information from sampled pixel blocks, etc. In accordance with one embodiment of the invention, the masking templates that correspond to standard medical images are organized in the masking template database 56 to be accessed using header and/or metadata information. The masking templates corresponding to report medical images are organized in the masking template database 56 to be accessed by determined pixel data, such as expected pixel data at the predetermined coordinates or expected pixel patterns.

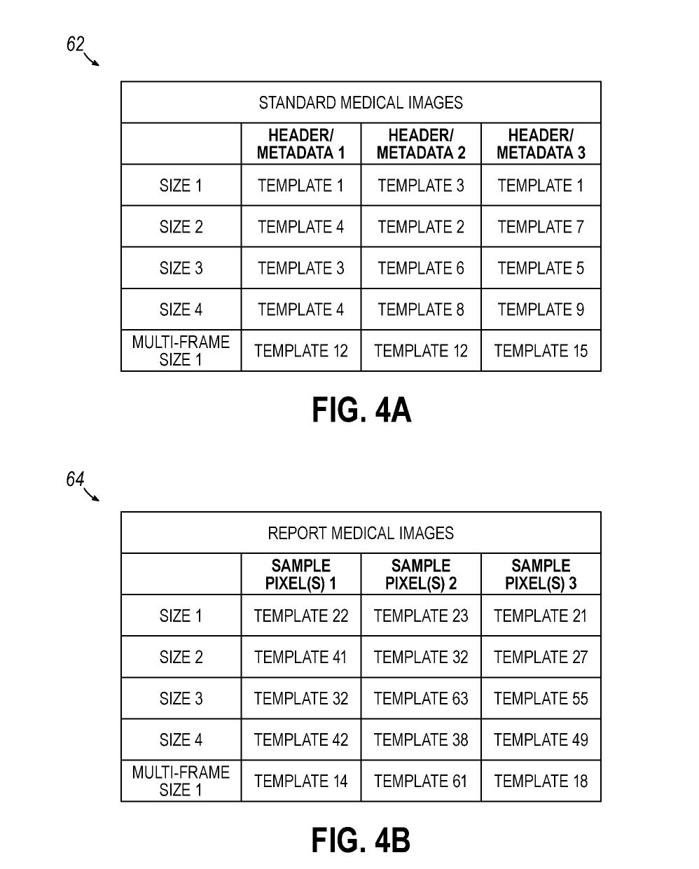

FIGS. 4A and 4B provide exemplary organizational structures of the masking templates in the masking template database 56. Although the templates are illustrated in the figures as being divided into two tables or sub-databases 62 and 64, each consisting of templates for standard medical images and templates for report medical images respectively, the templates could be arranged or further divided in other ways. For example, in addition or alternatively to medical image type (e.g., standard or report), the templates could be arranged or divided/subdivided into tables or sub-databases that are accessed according to expected pixel data at predetermined coordinates, expected pixel patterns, imaging device manufacturer, imaging device model number, imaging device software revision, modality and/or any other information that might be derived or determined in accordance with the invention, such as pixel information evaluated or information contained in the header or metadata of a medical image.

For illustrative purposes only, table 62 of FIG. 4A and table 64 of FIG. 4B are organized so as to use the type information to initially select a group of image templates for selection. Depending on the type of image, then the invention processes additional data for further determining the appropriate image template to be used. For example, as noted herein, the invention processes information about the image, such as using sampled pixel blocks in order to determine the type of image. If it is determined that the image is a standard medical image, then the table 62 of FIG. 4A is implemented and additional information from the header and/or metadata of the image is determined and used to further determine and select the corresponding masking template. Conversely, if it is determined by the invention that an image is a report medical image, then the table 64 of FIG. 4B is implemented and additional information from pixel analysis, such as sampled pixel blocks, is used to determine the corresponding masking template. In addition to organizing the templates by medical image type (standard or report), header and/or metadata information, expected pixel patterns, and/or expected pixel data at pre-determined coordinates, the masking template database 56 may also organize templates by size and by whether the template is for a single-frame or multi-frame image (e.g., a video). For example, as illustrated in FIG. 4A, a standard medical image having header/metadata 1 can potentially correspond to five different masking templates based upon the size of the image. Referring to FIG. 4A, four of these templates correspond to single-frame images of different sizes (i.e., sizes 1-4), and one of the templates corresponds to a multi-frame image. A similar arrangement is illustrated in FIG. 4B with respect to various different masking templates that are selectable by using size information, in addition to sampled pixel information, for report type medical images. Implementation of any one of the exemplary organizational structures of masking template database 56 discussed above may offer improvements over the prior art by enabling, based on processed information and data relating to the image, the automated masking of information burned into the image, a faster retrieval of a masking template for the image, and a faster masking of information burned into the image.

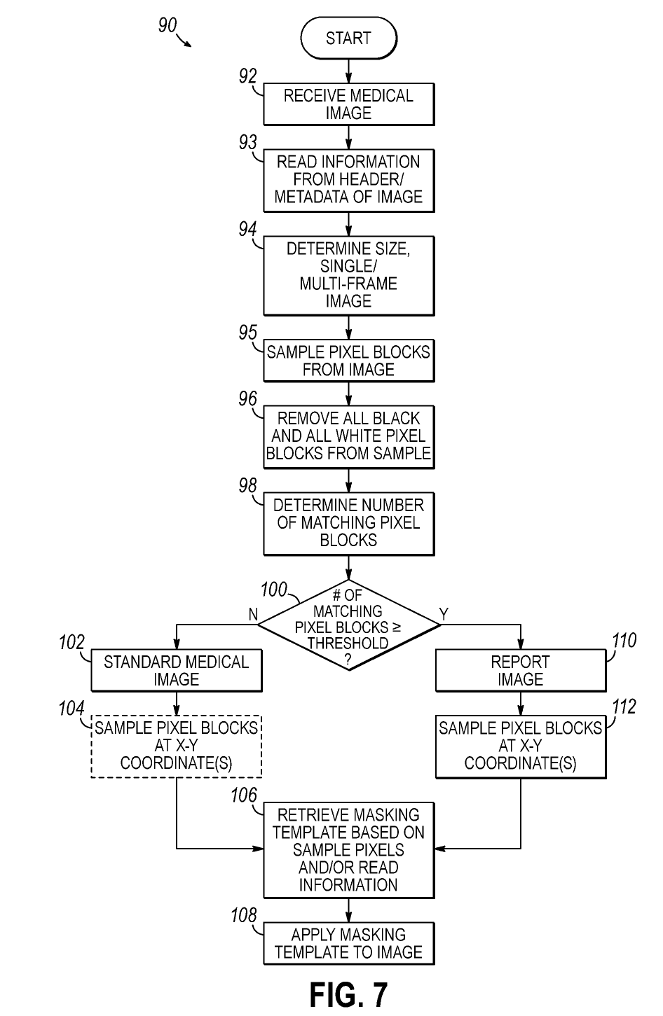

FIGS. 6 and 7 illustrate exemplary processes that may be performed by the medical image processing system 50 in accordance with embodiments of the invention. FIG. 6 provides one exemplary process 80 for masking sensitive or identifying information burned into a medical image. The process 80 begins at step 82, in which a medical image is received, such as from a medical imaging system/server 12 (See FIG. 1). The image may then be processed by an imaging processing system 14 using a masking module 54. As part of the processing of the masking module 54, header/metadata information is obtained or read from the medical image at step 84. Based on the obtained information, process 80 proceeds to step 86, where a masking template is retrieved using the header/metadata information. The masking template is selected and retrieved from a masking template data base 56, such as using information about the size of the image, the manufacturer of the imaging device, the model of the imaging device, etc., as illustrated in FIG. 5, for example. Using that data, various tables, such table 62 of FIG. 4A might be accessed. The specific template that is selected and retrieved is then applied at step 88 to the medical image by the imaging processing system and masking module in order to thereby redact or mask sensitive or identifying information burned therein, in accordance with one aspect of the invention. The process of FIG. 6 might be applied, for example, to a standard medical image wherein the masking template might be determined and selected using the header/metadata information without additional processing, such as pixel block sampling. Other embodiments of the invention use further processing in several steps to determine and select the appropriate masking template.

FIG. 7 provides another exemplary process 90 for masking sensitive or identifying information burned into a medical image using an initial or primary processing to evaluate and determine the type of medical image being addressed and then additional or secondary further processing to determine and select the appropriate masking template. Process 90 begins at step 92, where a medical image is received, such as from a medical imaging system/server 12 (See FIG. 1). Information and data regarding the image are then processed, such as by reading or obtaining information from the header/metadata associated with the image in step 92. Similarly, the size of the image and whether it is a single frame or multi-frame image might be determined as well, such as from information associated with the header/metadata of the image according to step 94. Thereafter, at step 95, additional processing is done with the image for the purposes of determining the type of image that is being processed. In one embodiment, initial pixel processing is done to determine the image type. More specifically, as illustrated for step 95, one or more pixel blocks are sampled from the medical image. As previously described, the sampling of pixel blocks may be randomized and sampled at random coordinates in the image or predetermined, such as being sampled at predetermined areas or coordinates of the image. At step 96, all black and all white pixel blocks may be removed from the sampled set of pixel blocks. Next, process 90 proceeds to step 98, where the number of matching pixel blocks from the set of remaining pixel blocks is determined (i.e., the cross-region matching algorithm might be used as described herein). At step 100, the process 90 determines whether the number of matching blocks is greater than or equal to a set threshold for the pixel block sampling process. As noted herein, such pixel pattern matching may be used to determine the image type.

If the number of matching pixel blocks from the pixel block processing is less than the set threshold (“NO” branch of step 100), a determination is made that the medical image is a standard medical image, as illustrated at step 102. In one embodiment of the invention, if the image is a standard medical image, the appropriate image masking template might be determined using the information obtained from the header/metadata (e.g., in step 93). As such, step 104 in the “NO” path might be bypassed. As illustrated in step 106, the header/metadata information might be used to access masking template database 56 (FIG. 3). At step 106, a masking template corresponding to the medical image data is retrieved to be used with the image in accordance with the invention. Then, at step 108, the masking template is applied to the image to redact sensitive or identifying information burned therein. For example, as illustrated in FIG. 4A, the table 62 might be used and accessed with the header/metadata information and size information to select a masking template.

In an alternative embodiment of the invention, even if the image is a standard medical image, additional or secondary pixel processing might be used in order to fine tune the masking template selection process. To that end, step 104 might be implemented to sample pixel blocks at X-Y coordinates (random or predetermined). The processed pixel information might then be used, along with header/metadata information, to determine and retrieve the appropriate masking template.

In the case of a report image, additional or secondary pixel processing might be used in order to access the masking template, such as is shown in FIG. 4B and table 64. Returning to step 100 in FIG. 7, if the number of matching pixel blocks is greater than or equal to the set threshold (“YES” branch of step 100), it is determined that the medical image is a report medical image at step 110. Following this determination, additional pixel processing is in order, and one or more pixel blocks are sampled at coordinates of the medical image, as illustrated at step 112. The coordinates could be predefined or determined, or they could be random. In one embodiment, pixel blocks are sampled at predefined coordinates. The Alternatively, data from the earlier pixel processing might be used, such as data associated with one or more of the pixel blocks sampled at step 94. The additional or secondary pixel processing and information therefrom is then used for determining and retrieving a masking template as in step 106. Referring to FIG. 4B, the sampled pixel data may be used to access the template table 64. In some embodiments, additional information may also be used from the header/metadata of the image, such as data obtained at step 93, in order to determine an appropriate masking template.

Regardless of the type of image, the process 90 thereafter proceeds to step 106, where a masking template corresponding to the medical image is retrieved based on the newly sampled or gathered pixel blocks and, if read, information from the header/metadata of the medical image. Finally, at step 108, the masking template is applied to the image to redact sensitive or identifying information burned therein.

When a medical image is received in processes 80 and 90, such medical image may be in the form of computer data. Thus, processes 80 and 90 may include receiving computer data representative of the medical image. This received data may be transformed into redacted data when the masking template is applied to the medical image. In other words, the received data may be transformed into redacted data by applying the masking template to the received data, where the redacted data represents the redacted medical image in a format intelligible by a computer or processor.

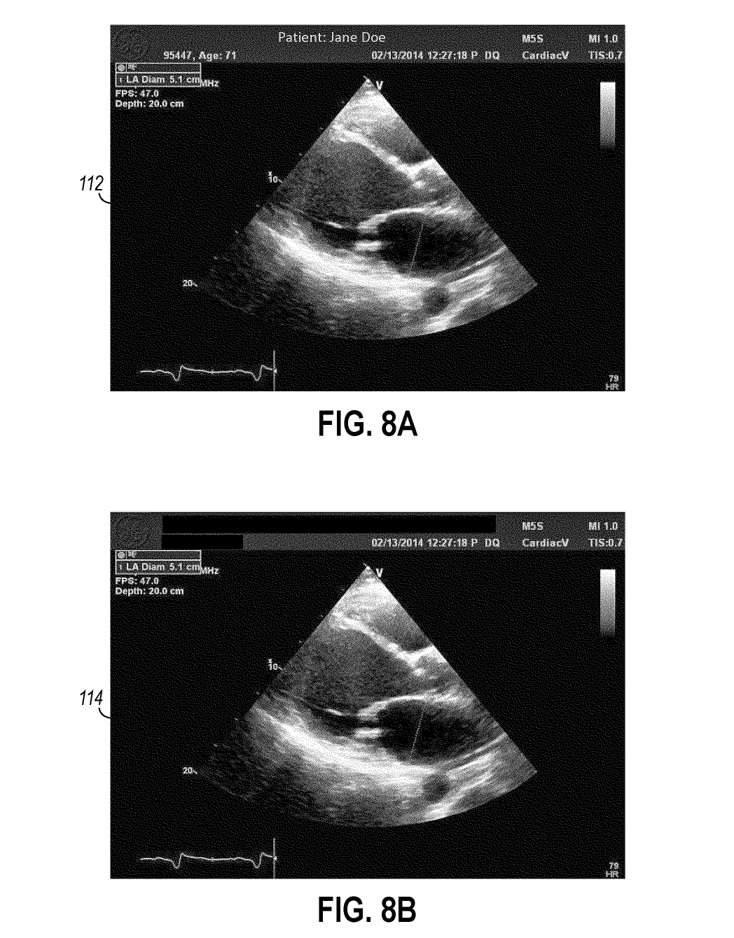

FIG. 8 provides an exemplary standard medical image before a masking template is applied and after the masking template is applied. Image 116 shows the standard medical image before the masking template is applied and thus includes the patient's name, ID number, and age in visible view. Image 118 shows the standard medical image after the masking template is applied, with the patient's name, ID number, and age now redacted in accordance with features of the invention.

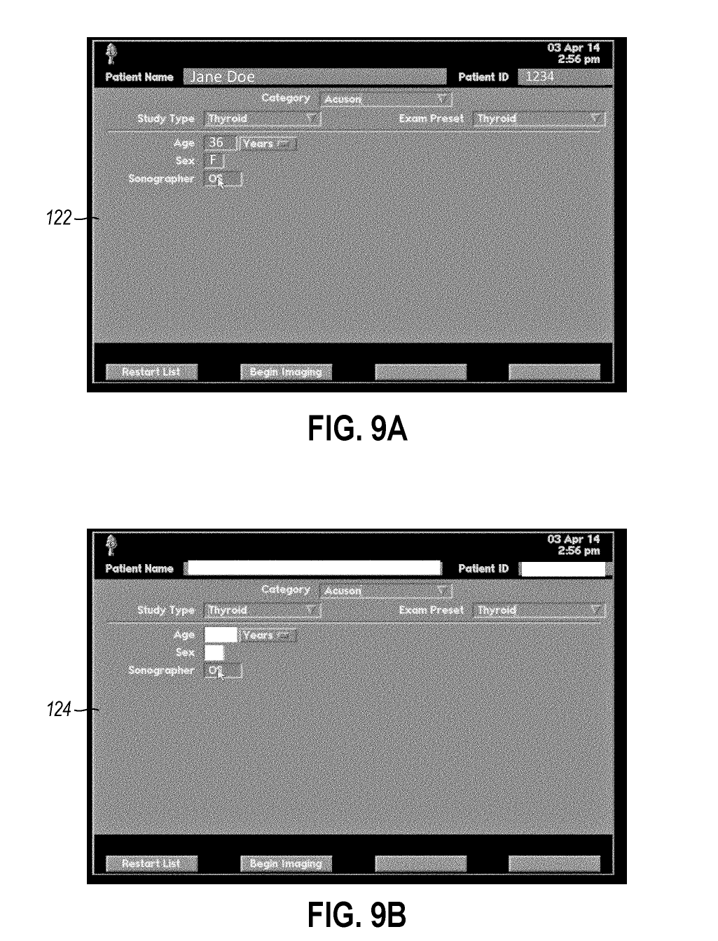

FIG. 9 provides an exemplary report medical image shown before a masking template is applied and after the masking template is applied. Image 122 shows the report medical image before the masking template is applied and thus includes the patient's age, ID number, age, and sex in visible view. Image 124 shows the report medical image after the masking template is applied, with the patient's name, ID number, age, and sex now redacted in accordance with features of the invention.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method for removing sensitive or identifying information in a medical image, the method comprising:
receiving, by at least one processor, a medical image, the medical image including pixel data and identification data;
obtaining, from the medical image, the identification data associated with the medical image;
sampling one or more pixel blocks of the pixel data from the medical image and processing the sampled pixel blocks to evaluate their content;
using the identification data and sampled pixel data and determining a masking template for the image;
applying the masking template to the medical image to mask the information in the medical image.

2. The method of claim 1, wherein the image may be of a plurality of types, the method further comprising processing the sampled pixel blocks and determining the type of the image from the sampled pixel blocks.

3. The method of claim 2 wherein the image is a report type image or a standard type image.

4. The method of claim 1 wherein determining a masking template includes using the identification data and sampled pixel data and accessing a database of selectable masking templates.

5. The method of claim 1, wherein applying the masking template includes redacting information in the medical image.

6. The method of claim 5, wherein the redacted information includes a name, age, and/or sex of a patient.

7. The method of claim 1, wherein the identification data of the medical image includes at least one of a header data or metadata.

8. The method of claim 1 wherein the identification data of the medical image includes at least one of manufacturer data, software revision data, modality data, size data and model number relating to the medical image.

9. The method of claim 1, wherein sampling one or more pixel blocks of the pixel data includes determining one or more patterns in the one or more sampled pixel blocks and based on the determined patterns, determining the masking template for the image.

10. The method of claim 2 further comprising performing an initial processing of the sampled pixel blocks to determine a type of image and then performing additional sampling of the pixel blocks to determine a masking template for the image.

11. The method of claim 3, further comprising:
if the medical image is determined to be a standard medical image, determining a masking template for the image based on identification data of the medical image;
if the medical image is determined to be a report medical image, determining a masking template for the image based on sampled pixel data.

12. A system for redacting information burned into a medical image, the system comprising:
at least one processor; and
a memory storing instructions that, when executed by the at least one processor, cause the system to:
receive a medical image, the medical image including pixel data and identification data;
obtain from the medical image, the identification data associated with the medical image;
sample one or more pixel blocks of the pixel data from the medical image and process the sampled pixel blocks to evaluate their content;
use the identification data and sampled pixel data and determine a masking template for the image;
apply the masking template to the medical image to mask the information in the medical image.

13. The system of claim 12 wherein the image may be of a plurality of types, the system further configured to process the sampled pixel blocks and determine the type of the image from the sampled pixel blocks.

14. The system of claim 13 wherein the image is a report type image or a standard type image.

15. The system of claim 12 wherein the system is further configured to determine a masking template using the identification data and sampled pixel data and access a database of selectable masking templates.

16. The system of claim 12, wherein the system is further configured to apply the masking template and redact information in the medical image.

17. The system of claim 12, wherein the identification data of the medical image includes at least one of a header data or metadata.

18. The system of claim 12, wherein the system is further configured to sample one or more pixel blocks of the pixel data and to determine one or more patterns in the one or more sampled pixel blocks and based on the determined patterns, to determine the masking template for the image.

19. The system of claim 13 wherein the system is further configured to perform an initial processing of the sampled pixel blocks to determine a type of image and then to perform additional sampling of the pixel blocks to determine a masking template for the image.

20. The system of claim 14, wherein the system is further configured:
if the medical image is determined to be a standard medical image, to determine a masking template for the image based on identification data of the medical image;
if the medical image is determined to be a report medical image, to determine a masking template for the image based on sampled pixel data.
